(19) United States
(12) Patent Application Publication
(10) Pub. No.: US 2026/0266610 A1
(43) Pub. Date: Sep. 10, 2026

(54) Inertial-based integrated navigation method and device for enhancing Lie group autonomous characteristic

(71) Applicant: NATIONAL UNIVERSITY OF DEFENSE TECHNOLOGY, Changsha (CN)

(72) Inventors: Maosong WANG, Changsha (CN); Wenqi WU, Changsha (CN); Jiarui CUI, Changsha (CN); Peiqi LI, Changsha (CN)

(73) Assignee: NATIONAL UNIVERSITY OF DEFENSE TECHNOLOGY, Changsha (CN)

(21) Appl. No.: 19/227,517

(22) Filed: Jun. 4, 2025

(30) Foreign Application Priority Data
Mar. 7, 2025 (CN) 202510269522X

(51) Int. Cl. G01C 21/16; G01C 21/00; G01C 21/20

(52) U.S. Cl. CPC G01C 21/188; G01C 21/005; G01C 21/20

(57) ABSTRACT

An inertial-based integrated navigation method and device for enhancing a Lie group autonomous characteristic aims to address the technical problems of existing integrated navigation Lie group models, such insufficient autonomous characteristic and low navigation accuracy under large misalignment angle conditions. The inertial-based integrated navigation method constructs a world frame projection-based Kalman filter system equation for enhancing a Lie group autonomous characteristic according to a moving body's initial navigation state and strapdown inertial navigation system (SINS) navigation information. The inertial-based integrated navigation method achieves dual reference frame fusion by integrating inertial frame velocity representation with Earth frame attitude/position representation, thereby enhancing the autonomous characteristic of the integrated navigation system. Compared with conventional methods, the inertial-based integrated navigation method can significantly improve the robustness and positioning accuracy of the integrated navigation system under large misalignment angle conditions.

### CROSS REFERENCE TO THE RELATED APPLICATIONS

This application is based upon and claims priority to Chinese Patent Application No. 202510269522.X, filed on Mar. 7, 2025, the entire contents of which are incorporated herein by reference.

### TECHNICAL FIELD

The present disclosure mainly relates to the technical field of inertial navigation, and in particular to an inertial-based integrated navigation method and device for enhancing a Lie group autonomous characteristic.

### BACKGROUND

In scenarios where satellite navigation is available, strapdown inertial navigation system (SINS)/global navigation satellite system (GNSS) loosely/tightly coupled integrated navigation systems can achieve high navigation accuracy. However, in satellite-denied environments such as tunnels, underground facilities, and electromagnetic countermeasure environments, autonomous navigation technologies face severe challenges. Existing land vehicle navigation systems predominantly adopt schemes that fuse velocity sensors (e.g., odometers, Doppler velocity meters) with SINS, constraining SINS error accumulation through velocity information. However, this scheme faces the following three significant technical bottlenecks:

(1) System parameter sensitivity problems. Precise pre-calibration of installation misalignment angles, lever arm parameters between the SINS and velocity measurement devices, and scale factors of velocity measurement devices are required. However, in practical applications, time-varying deviations of these parameters caused by vehicle deformation and road condition variations render conventional fixed-parameter models ineffective.

(2) State estimation reliability problems. When the vehicle remains stationary or moves in a straight line for extended periods, state variables such as gyroscope bias, accelerometer bias, and installation misalignment angles exhibit weak observability. This leads to estimation divergence in conventional extended Kalman filters (EKFs) under strongly coupled nonlinear conditions.

(3) Large misalignment angle alignment problems. On-the-move initial alignment under satellite-denied environments requires handling scenarios with large attitude errors. Existing matrix Lie group models inherently lack a sufficient autonomous characteristic, resulting in significantly degraded navigation parameter estimation accuracy under large misalignment angle conditions.

In particular, existing matrix Lie group navigation models fail to fully account for reference frame projection relationships and the influence of the moving body's initial state during error state transformation. This leads to insufficient autonomous characteristic in error models and difficulty in maintaining the diffeomorphic properties of the Lie group manifold. This has become a key technical bottleneck restricting integrated navigation accuracy in highly dynamic environments.

### SUMMARY

In view of the autonomous characteristic defect of existing matrix Lie group-based navigation models and their applicability issue in large misalignment angle scenarios, the present disclosure proposes an inertial-based integrated navigation method and device for enhancing a Lie group autonomous characteristic to achieve improved navigation performance.

To achieve the above objective, the present disclosure adopts the following technical solutions.

In a first aspect, the present disclosure provides an inertial-based integrated navigation method and device for enhancing a Lie group autonomous characteristic, including:
receiving SINS navigation information, odometer navigation information, and positioning system navigation information of a moving body;
constructing, according to an initial navigation state and the SINS navigation information of the moving body, a world frame projection-based Kalman filter system equation for enhancing a Lie group autonomous characteristic;
taking an estimated velocity of an odometer as an observed quantity, and constructing a velocity observation equation;
performing inertial-based integrated navigation according to the world frame projection-based Kalman filter system equation for enhancing a Lie group autonomous characteristic and the velocity observation equation, and obtaining an inertial-based integrated navigation state and covariance as a Kalman filter's observation-updated state and covariance; and
performing attitude, velocity, and position updates according to a Lie group error state transformation.

In the present disclosure, the SINS navigation information includes: navigation timestamp, information in local navigation frame;
the odometer navigation information includes: navigation timestamp and body velocity; and
the positioning system navigation information refers to navigation information from a satellite positioning system or an acoustic positioning system, including navigation timestamp and absolute three-dimensional positioning information.

In another aspect, the present disclosure provides an inertial-based integrated navigation device for enhancing a Lie group autonomous characteristic, including:
a first module, configured to receive SINS navigation information, odometer navigation information, and positioning system navigation information of a moving body;
a second module, configured to construct, according to an initial navigation state and the SINS navigation information of the moving body, a world frame projection-based Kalman filter system equation for enhancing a Lie group autonomous characteristic;
a third module, configured to take an estimated velocity of an odometer as an observed quantity, and construct a velocity observation equation;
a fourth module, configured to perform inertial-based integrated navigation according to the world frame projection-based Kalman filter system equation for enhancing a Lie group autonomous characteristic and the velocity observation equation, and obtain an inertial-based integrated navigation state and covariance as a Kalman filter's observation-updated state and covariance; and
a fifth module, configured to perform attitude, velocity, and position updates according to a Lie group error state transformation.

In another aspect, the present disclosure provides a computer device, including a memory and a processor, where the memory is configured to store a computer program; and the computer program is executable by the processor to implement the steps of the above inertial-based integrated navigation method and device for enhancing a Lie group autonomous characteristic.

In another aspect, the present disclosure provides a computer-readable storage medium, where the computer-readable storage medium is configured to store a computer program; and the computer program is executable by a processor to implement the steps of the above inertial-based integrated navigation method and device for enhancing a Lie group autonomous characteristic.

In another aspect, the present disclosure provides a computer program product, where the computer program product is stored on a computer-readable storage medium, and includes a computer instruction; and the computer instruction is run by a processor, such that a computer device implements the steps of the above inertial-based integrated navigation method and device for enhancing a Lie group autonomous characteristic.

Compared with the prior art, the present disclosure has the following beneficial effects:

The present disclosure constructs a world frame projection-based Kalman filter system equation for enhancing a Lie group autonomous characteristic according to the moving body's initial navigation state and SINS navigation information. Thus, the present disclosure achieves dual reference frame fusion by integrating inertial frame velocity representation with Earth frame attitude/position representation, thereby enhancing the autonomous characteristic of the integrated navigation system.

Furthermore, the present disclosure establishes a right-invariant error-defined Lie group extended Kalman filter (LG-EKF-R) algorithm, demonstrating superior comprehensive advantages in accuracy and computational efficiency compared to left-invariant error-defined models.

Furthermore, the error model derivation in the present disclosure deducts the influence of the moving body's initial velocity and position, thereby simplifying initial variance settings.

Compared with conventional methods, the present disclosure can significantly improve the robustness and positioning accuracy of the integrated navigation system under large misalignment angle conditions.

### BRIEF DESCRIPTION OF THE DRAWINGS

To describe the technical solutions in the embodiments of the present disclosure or in the prior art more clearly, the following briefly describes the drawings required for describing the embodiments or the prior art. Apparently, the drawings in the following description show some embodiments of the present disclosure, and those of ordinary skill in the art may still derive other drawings from these drawings without creative efforts.

FIG. 1 is a flowchart of an inertial-based integrated navigation method for enhancing a Lie group autonomous characteristic according to an embodiment;

FIG. 2 is a schematic diagram showing the configuration of a vehicle-borne SINS/odometer integrated navigation space;

FIG. 3 is a diagram of a trajectory for a vehicle experiment;

FIG. 4 is a comparison diagram of integrated navigation results between an extended Kalman filter (EKF) and an inertial-based integrated navigation method using a Lie group right-invariant error defined projection frame as Earth frame (LG-EKF-e) under initial horizontal attitude error angle of 1° and a heading error angle of 180°; and

FIG. 5 is a comparison diagram of integrated navigation results between a velocity error state transformation extended Kalman filter (ST-EKF) and a filtering method (LG-EKF-w) of the present disclosure under initial horizontal attitude error angle of 1° and a heading error angle of 180°.

### DETAILED DESCRIPTION OF THE EMBODIMENTS

The following clearly and completely describes the technical solutions in the embodiments of the present disclosure with reference to the drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

The present disclosure provides an inertial-based integrated navigation method for enhancing a Lie group autonomous characteristic. The present disclosure aims to replace the conventional extended Kalman filter (EKF) with a world frame projection-based Lie group Kalman filter. The present disclosure achieves more precise navigation and positioning results by taking the inertial space as the velocity reference frame, the Earth frame as the attitude/position reference frame, and the world frame as the projection frame.

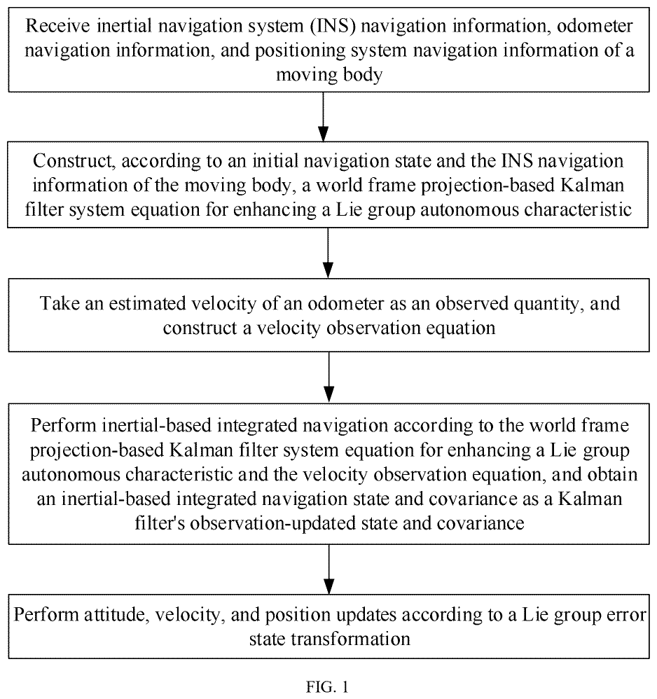

As shown in FIG. 1, an embodiment provides an inertial-based integrated navigation method for enhancing a Lie group autonomous characteristic, including the following steps.

SINS navigation information, odometer navigation information, and positioning system navigation information of a moving body are received.

According to an initial navigation state and the SINS navigation information of the moving body, a world frame projection-based Kalman filter system equation for enhancing a Lie group autonomous characteristic is constructed.

An estimated velocity of an odometer is taken as an observed quantity, and a velocity observation equation is constructed.

Inertial-based integrated navigation is performed according to the world frame projection-based Kalman filter system equation for enhancing a Lie group autonomous characteristic and the velocity observation equation, and an inertial-based integrated navigation state and covariance are obtained as a Kalman filter's observation-updated state and covariance.

Attitude, velocity, and position updates are performed according to a Lie group error state transformation.

In the present disclosure, the SINS navigation information includes: navigation timestamp, information in local navigation frame.

The odometer navigation information includes: navigation timestamp and body velocity.

The positioning system navigation information refers to navigation information from a satellite positioning system or an acoustic positioning system, including navigation timestamp and absolute three-dimensional positioning information.

Furthermore, the world frame projection-based Kalman filter system equation for enhancing a Lie group autonomous characteristic is constructed as follows.

SINS frame is denoted as a b-frame, and world frame is denoted as a w-frame.

The filter state vector x_{LGEKF-INS-Odo-W-R} is defined as follows:

$${x}_{LGEKF - INS - Odo - W - R} = {[ \begin{matrix}{( {ϕ}_{wb}^{w} )}^{T} & {( J {ρ}_{vib}^{wR} )}^{T} & {( J {ρ}_{rwb}^{wR} )}^{T} & {( {ε}^{b} )}^{T} & {( {∇}^{b} )}^{T} & δ {k}_{odo} & {α}_{θ} & {α}_{ψ} & {( δ {L}^{b} )}^{T}\end{matrix} ]}^{T}$$

where,

$${ϕ}_{wb}^{w}$$

denotes attitude error vector of the SINS;

$$J {ρ}_{vib}^{wR}$$

denotes right Lie group velocity error vector defined relative to the inertial frame and projected onto the w-frame;

$$J {ρ}_{rwb}^{wR}$$

denotes right Lie group position error vector defined relative to the w-frame and projected onto the w-frame; ε^{b} denotes gyroscope constant bias vector; ∇^{b} denotes accelerometer constant bias vector; δk_{odo} denotes an odometer scale factor error; and α_{θ}, α_{ψ}, δL^{b} denote pitch installation misalignment angle and yaw installation misalignment angle between the SINS and the odometer and lever arm error vector, modeled as:

$$δ {\dot{k}}_{odo} = - \frac{1}{{τ}_{odo}} δ {k}_{odo} + {w}_{odo} , {\dot{α}}_{θ} = 0 , {\dot{α}}_{ψ} = 0 , δ {\dot{L}}^{b} = {0}_{3 \times 1}$$

where, τ_{odo} denotes the correlation time of the first-order Markov process; and w_{odo} denotes the odometer noise.

The world frame projection-based integrated navigation system equation for enhancing a Lie group autonomous characteristic is:

$${\dot{x}}_{LGEKF - INS - Odo - W - R} = {F}_{LGEKF - INS - Odo - W - R} {x}_{LGEKF - INS - Odo - W - R} + {G}_{LGEKF - INS - Odo - W - R} {w}_{gyro \_ acc \_ odo}$$

where, SINS frame is denoted as a b-frame, world frame is denoted as a w-frame, and \dot{x}_{LGEKF-INS-Odo-W-R} denotes a derivative of a filter state vector x_{LEIF-INS-Odo-W-R}.

$${F}_{LGEKF - INS - Odo - W - R} = [ \begin{matrix}{F}_{LGEKF - INS - W - R} & {0}_{15 \times 1} & {0}_{15 \times 1} & {0}_{15 \times 1} & {0}_{15 \times 3} \\ {0}_{1 \times 15} & - \frac{1}{{τ}_{odo}} & 0 & 0 & {0}_{1 \times 3} \\ {0}_{1 \times 15} & 0 & 0 & 0 & {0}_{1 \times 3} \\ {0}_{1 \times 15} & 0 & 0 & 0 & {0}_{1 \times 3} \\ {0}_{3 \times 15} & {0}_{3 \times 1} & {0}_{3 \times 1} & {0}_{3 \times 1} & {0}_{3 \times 3}\end{matrix} ]$$

$${F}_{LGEKF - INS - W - R} = [ \begin{matrix}- ( {ω}_{ie}^{w} \times ) & {0}_{3 \times 3} & {0}_{3 \times 3} & - {C}_{b}^{w} & {0}_{3 \times 3} \\ [ ( {\tilde{γ}}_{ib}^{w} - {( {ω}_{ie}^{w} \times )}^{2} ( {r}_{ew}^{w} + {r}_{wb ( 0 )}^{w} ) ) \times ] & - ( {ω}_{ie}^{w} \times ) & {0}_{3 \times 3} & - [ ( {\tilde{v}}_{ib}^{w} - ( {ω}_{ie}^{w} \times ) ( {r}_{ew}^{w} + {r}_{wb ( 0 )}^{w} ) ) \times ] {C}_{b}^{w} & - {C}_{b}^{w} \\ {0}_{3 \times 3} & {I}_{3} & - ( {ω}_{ie}^{w} \times ) & - [ ( {\tilde{r}}_{wb}^{w} - {r}_{wb ( 0 )}^{w} ) \times ] {C}_{b}^{w} & {0}_{3 \times 3} \\ {0}_{3 \times 3} & {0}_{3 \times 3} & {0}_{3 \times 3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3}\end{matrix} ]$$

$${w}_{gyro \_ acc \_ odo} = {[ \begin{matrix}{w}_{gx} & {w}_{gy} & {w}_{gz} & {w}_{ax} & {w}_{ay} & {w}_{az} & {w}_{odo}\end{matrix} ]}^{T}$$

$${G}_{LGEKF - INS - Odo - W - R} = [ \begin{matrix}- {C}_{b}^{w} & {0}_{3 \times 3} & {0}_{3 \times 1} \\ - [ ( {\tilde{v}}_{ib}^{w} - ( {ω}_{ie}^{w} \times ) ( {r}_{ew}^{w} + {r}_{wb ( 0 )}^{w} ) ) \times ] {C}_{b}^{w} & - {C}_{b}^{w} & {0}_{3 \times 1} \\ - [ ( {\tilde{r}}_{wb}^{w} - {r}_{wb ( 0 )}^{w} ) \times ] {C}_{b}^{w} & {0}_{3 \times 3} & {0}_{3 \times 1} \\ {0}_{6 \times 3} & {0}_{6 \times 3} & {0}_{6 \times 1} \\ {0}_{1 \times 3} & {0}_{1 \times 3} & 1 \\ {0}_{5 \times 3} & {0}_{5 \times 3} & {0}_{5 \times 1}\end{matrix} ]$$

where, τ_{Odo} denotes correlation time of a first-order Markov process;

$${ω}_{ie}^{w}$$

denotes projection of an Earth rotation vector onto the w-frame;

$${C}_{b}^{w}$$

denotes direction cosine matrix from the b-frame to the w-frame;

$${\tilde{γ}}_{ib}^{w}$$

denotes computed value of gravitational acceleration projected onto the w-frame;

$${r}_{ew}^{w}$$

denotes projection of position of the w-frame relative to an e-frame onto the w-frame, where the e-frame refers to Earth frame;

$${r}_{wb ( 0 )}^{w}$$

denotes projection of initial position of the moving body relative to the w-frame onto the w-frame;

$${\tilde{v}}_{ib}^{w}$$

denotes computed value of projection of velocity of the moving body relative to inertial frame (i-frame) in the w-frame;

$${\tilde{r}}_{wb}^{w}$$

denotes computed value of projection of position of the moving body relative to the w-frame onto the w-frame; x denotes conversion of a vector into a corresponding antisymmetric matrix; ␣ means that the parameter is computed value; wₐ=[wₐₓ w_{ay} w_{az}]^{T} and w_{g}=[w_{gx} w_{gy} w_{gz}]^{T} denote accelerometer noise vector and gyroscope noise vector, respectively; and w_{odo} denotes odometer noise.

Furthermore, a differential equation for the attitude error vector

$${ϕ}_{wb}^{w}$$

### of the SINS is:

$${\dot{ϕ}}_{wb}^{w} \approx - ( {ω}_{ie}^{w} \times ) {ϕ}_{wb}^{w} - {\tilde{C}}_{b}^{w} δ {ω}_{ib}^{b}$$

where, ωᵢₑ^{w} denotes the projection of the Earth rotation vector onto the w-frame;

$${\tilde{C}}_{b}^{w}$$

denotes computed value of the direction cosine matrix from the b-frame to the w-frame; and

$$δ {ω}_{ib}^{b}$$

denotes gyroscope error.

In the present disclosure, a differential equation for the right Lie group velocity error

$$J {ρ}_{vib}^{wR} is : J {\dot{ρ}}_{vib}^{wR} \approx [ {\tilde{γ}}_{ib}^{w} - {( {ω}_{ie}^{w} \times )}^{2} ( {r}_{ew}^{w} + {r}_{wb ( 0 )}^{w} ) ] {ϕ}_{eb}^{w} - ( {ω}_{ie}^{w} \times ) J {ρ}_{vib}^{wR} - δ {γ}_{ib}^{w} - [ ( {\tilde{v}}_{i b}^{w} - ( {ω}_{ie}^{w} \times ) ( {r}_{ew}^{w} + {r}_{wb ( 0 )}^{w} ) ] {\tilde{C}}_{b}^{w} δ {ω}_{ib}^{b} - {\tilde{C}}_{b}^{w} δ {f}_{ib}^{b}$$

where,

$${ϕ}_{eb}^{w}$$

denotes projection of the attitude error vector of the SINS relative to the e-frame onto the w-frame; and

$$δ {f}_{ib}^{b}$$

denotes accelerometer error.

A differential equation for the right Lie group position error vector

$$J {ρ}_{rwb}^{wR} is : J {\dot{ρ}}_{rwb}^{wR} \approx J {ρ}_{vib}^{wR} - ( {ω}_{ie}^{w} \times ) J {ρ}_{rwb}^{wR} - [ ( {\tilde{r}}_{wb}^{w} - {r}_{wb ( 0 )}^{w} ) \times ] {\tilde{C}}_{b}^{w} δ {ω}_{ib}^{b}$$

where,

$${\tilde{C}}_{b}^{w}$$

denotes computed value of the direction cosine matrix from the b-frame to the w-frame; and

$$δ {ω}_{i b}^{b}$$

denotes gyroscope error.

The gyroscope constant bias, the accelerometer constant bias, the lever arm error, and the pitch installation misalignment angle and the yaw installation misalignment angle between the SINS and the odometer are considered constant, and the odometer scale factor error is considered as the first-order Markov process, with respective differential equations defined as follows:

$${\dot{ε}}^{b} = 0 , {\dot{∇}}^{b} = 0$$

$$δ {\dot{k}}_{o d o} = - \frac{1}{{τ}_{o d o}} δ {k}_{odo} + {w}_{odo} , {\dot{α}}_{θ} = 0 , {\dot{α}}_{ψ} = 0 , δ {\dot{L}}^{b} = {0}_{3 \times 1}$$

In the present disclosure, the estimated velocity of the odometer is obtained by applying a lever arm correction to a velocity computed by the SINS. It is expressed in the odometer frame, namely m-frame, as follows:

$$\begin{matrix}{\tilde{v}}_{INS \_ odo}^{m} = {\tilde{C}}_{b}^{m} [ {\tilde{C}}_{w}^{b} {\tilde{v}}_{w b}^{w} + ( {ω}_{w b}^{b} \times {\tilde{L}}^{b} ) ] \\ = ( {I}_{3} - α \times ) {C}_{b}^{m} [ {C}_{w}^{b} ( {I}_{3} + {ϕ}_{w b}^{w} \times ) ( {v}_{w b}^{w} + δ {v}_{w b}^{w} ) + ( {ω}_{w b}^{b} \times {\tilde{L}}^{b} ) ] \\ = \begin{matrix}( {I}_{3} - α \times ) {C}_{b}^{m} [ {C}_{w}^{b} ( {I}_{3} + {ϕ}_{w b}^{w} \times ) ( {v}_{w b}^{w} + [ ( {\tilde{v}}_{ib}^{w} - ( {ω}_{i e}^{w} \times ) ( {r}_{e w}^{w} + \\ {r}_{w b}^{w} ) ) \times ] {ϕ}_{w b}^{w} - J {ρ}_{v i b}^{w R} + ( {ω}_{i e}^{w} \times ) J {ρ}_{r w b}^{w R} ) + ( {ω}_{w b}^{b} \times {\tilde{L}}^{b} ) ]\end{matrix} \\ = \begin{matrix}{I}_{3} - α \times ) {C}_{b}^{m} {C}_{w}^{b} ( {I}_{3} + {ϕ}_{w b}^{w} \times ) \{ {v}_{w b}^{w} + ( {\tilde{v}}_{w b}^{w} \times ) {ϕ}_{w b}^{w} - \\ J {ρ}_{v i b}^{w R} + ( {ω}_{i e}^{w} \times ) J {ρ}_{r w b}^{w R} \} + {C}_{b}^{m} ( {ω}_{e b}^{b} \times ) ( {L}^{b} + δ {L}^{b} )\end{matrix}\end{matrix}$$

where,

$${\tilde{v}}_{INS \_ odo}^{m}$$

denotes equivalent velocity computed by the SINS and projected onto the odometer m-frame; and the m-frame refers to the odometer frame.

According to:

$${v}_{o d o}^{m} = {C}_{b}^{m} [ {C}_{w}^{b} {v}_{w b}^{w} + ( {ω}_{w b}^{w} \times ) {L}^{b} ]$$

Neglecting second-order terms yields the velocity observation equation:

$$\begin{matrix}δ {z}_{v} = {\tilde{v}}_{INS \_ odo}^{m} - {\tilde{v}}_{odo}^{m} \\ = \begin{matrix}{v}_{o d o}^{m} - {C}_{b}^{m} {C}_{w}^{b} J {ρ}_{v i b}^{w R} + {C}_{b}^{m} {C}_{w}^{b} ( {ω}_{i e}^{w} \times ) J {ρ}_{rwb}^{w R} + \\ ( {v}_{o d o}^{m} \times ) α + {C}_{b}^{m} ( {ω}_{w b}^{b} \times ) δ {L}^{b} - ( 1 + δ {k}_{o d o} ) {v}_{o d o}^{m} + {υ}_{o d o}\end{matrix} \\ = \begin{matrix}- {C}_{b}^{m} {C}_{w}^{b} J {ρ}_{v i b}^{w R} + {C}_{b}^{m} {C}_{w}^{b} ( {ω}_{i e}^{w} \times ) J {ρ}_{rwb}^{w R} - \\ {v}_{o d o}^{m} δ {k}_{o d o} + ( {v}_{o d o}^{m} \times ) α + {C}_{b}^{m} ( {ω}_{w b}^{b} \times ) δ {L}^{b} + {v}_{o d o}\end{matrix} \\ = {H}_{v \_ LGEKF - INS - Odo - W - R} {x}_{LGEKF - INS - Odo - W - R} + {υ}_{odo}\end{matrix}$$

where,

$${v}_{odo}^{m}$$

denotes velocity output by the odometer in the m-frame;

$${\tilde{v}}_{odo}^{m}$$

denotes velocity output by the odometer in the m-frame; the velocity observation matrix is

$${H}_{v \_ LGEKF - INS - Odo - W - R} = [ \begin{matrix}{0}_{3 \times 3} & - {C}_{b}^{m} {C}_{w}^{b} & {C}_{b}^{m} {C}_{w}^{b} ( {ω}_{i e}^{w} \times ) & {0}_{3 \times 6} & {M}_{v}^{b} & {C}_{b}^{m} ( {ω}_{w b}^{b} \times ) ] ;\end{matrix}$$

υ_{Odo} denotes velocity observation noise;

$${C}_{b}^{m}$$

denotes attitude transformation matrix from the b-frame to the m-frame;

$${C}_{w}^{b}$$

denotes attitude transformation matrix from the w-frame to the b-frame; and

$${ω}_{w b}^{b}$$

denotes projection of angular velocity of the moving body relative to the w-frame onto the SINS frame, α=[0 α_{θ} α_{ψ}]^{T}.

$${M}_{v}^{b} = [ \begin{matrix}- {v}_{o d o} & 0 & 0 \\ 0 & 0 & - {v}_{o d o} \\ 0 & {v}_{o d o} & 0\end{matrix} ]$$

ν_{odo} denotes forward velocity of the odometer.

When the attitude, velocity, and position updates are performed according to a Lie group error state transformation, the attitude, velocity, and position updates are as follows:

$$\begin{matrix}[ \begin{matrix}{C}_{b}^{w} & \begin{matrix}{v}_{i b}^{w} - ( {ω}_{i e}^{w} \times ) \\ ( {r}_{e w}^{w} + {r}_{w b ( 0 )}^{w} )\end{matrix} & \begin{matrix}{r}_{wb}^{w} - \\ {r}_{w b ( 0 )}^{w}\end{matrix} \\ {0}_{1 \times 3} & 1 & 0 \\ {0}_{1 \times 3} & 0 & 1\end{matrix} ] = [ \begin{matrix}exp ( {ϕ}_{wb}^{w} \times ) & J {ρ}_{v i b}^{w R} & J {ρ}_{r w b}^{w R} \\ {0}_{1 \times 3} & 1 & 0 \\ {0}_{1 \times 3} & 0 & 1\end{matrix} ] [ \begin{matrix}{\tilde{C}}_{b}^{w} & \begin{matrix}{\tilde{v}}_{i b}^{w} - ( {ω}_{i e}^{w} \times ) \\ ( {r}_{e w}^{w} + {r}_{w b ( 0 )}^{w} )\end{matrix} & \begin{matrix}{\tilde{r}}_{wb}^{w} - \\ {r}_{w b ( 0 )}^{w}\end{matrix} \\ {0}_{1 \times 3} & 1 & 0 \\ {0}_{1 \times 3} & 0 & 1\end{matrix} ] \\ \approx [ \begin{matrix}{I}_{3} & + ( {ϕ}_{w b}^{w} & \times ) & J {ρ}_{v i b}^{w R} & J {ρ}_{r w b}^{w R} \\ & {0}_{1 \times 3} & & 1 & 0 \\ & {0}_{1 \times 3} & & 0 & 1\end{matrix} ] [ \begin{matrix}{\tilde{C}}_{b}^{w} & \begin{matrix}{\tilde{v}}_{i b}^{w} - ( {ω}_{i e}^{w} \times ) \\ ( {r}_{e w}^{w} + {r}_{w b ( 0 )}^{w} )\end{matrix} & \begin{matrix}{\tilde{r}}_{wb}^{w} - \\ {r}_{w b ( 0 )}^{w}\end{matrix} \\ {0}_{1 \times 3} & 1 & 0 \\ {0}_{1 \times 3} & 0 & 1\end{matrix} ]\end{matrix}$$

where,

$${v}_{ib}^{w}$$

denotes the projection of the velocity of the moving body relative to the inertial frame onto the w-frame;

$${\tilde{v}}_{ib}^{w}$$

denotes computed value of the projection of the velocity of the moving body relative to the inertial frame onto the w-frame;

$${r}_{wb}^{w}$$

denotes the projection of the position of the moving body relative to the w-frame onto the w-frame; and

$${\tilde{r}}_{wb}^{w}$$

denotes the computed value of the projection of the position of the moving body relative to the w-frame onto the w-frame.

The present disclosure innovatively constructs a composite parameter model integrating velocity representation relative to the inertial frame with attitude and position representation relative to the Earth frame. The present disclosure establishes canonical Lie algebra mapping of error states through world frame projection, ensuring that the error state equation is rigorously constrained to satisfy the autonomous characteristic of the Lie group manifold.

The present disclosure establishes a right-invariant error-defined Lie group extended Kalman filter (LG-EKF-R) algorithm. Compared with conventional left-invariant error models, this architecture exhibits superior local linear approximation characteristics, reducing computational complexity while maintaining estimation accuracy.

Regarding the initial navigation state decoupling technique in the present disclosure, the error model derivation employs explicit decoupling of the moving body's initial velocity/position parameters. By introducing normalized initial variance condition settings, it significantly enhances filter convergence velocity.

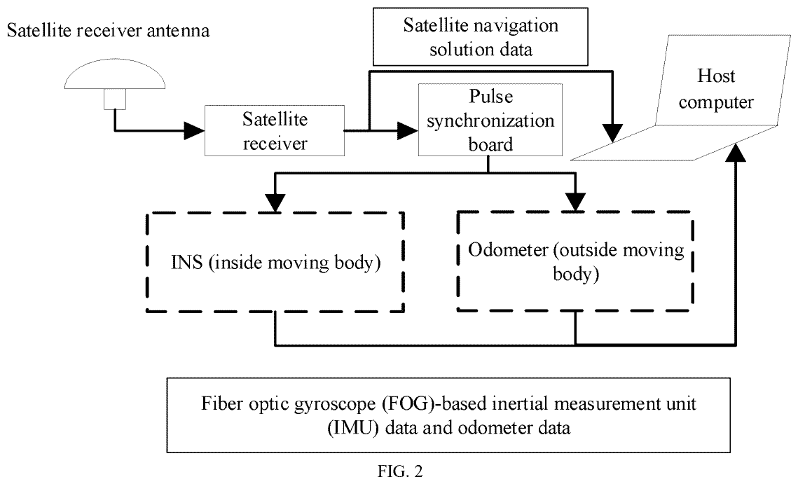

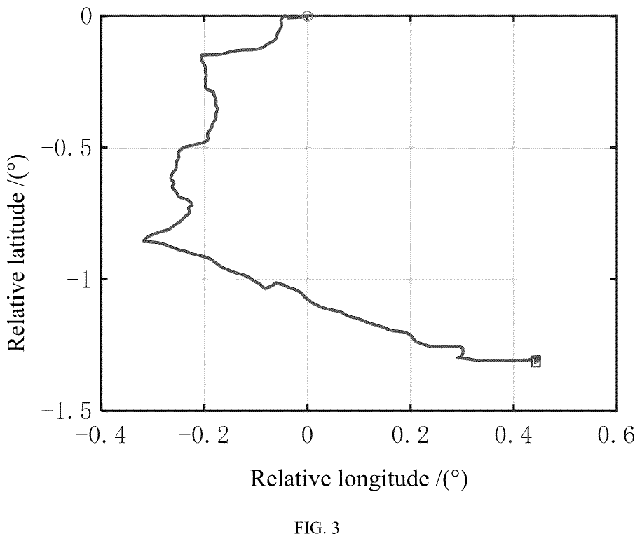

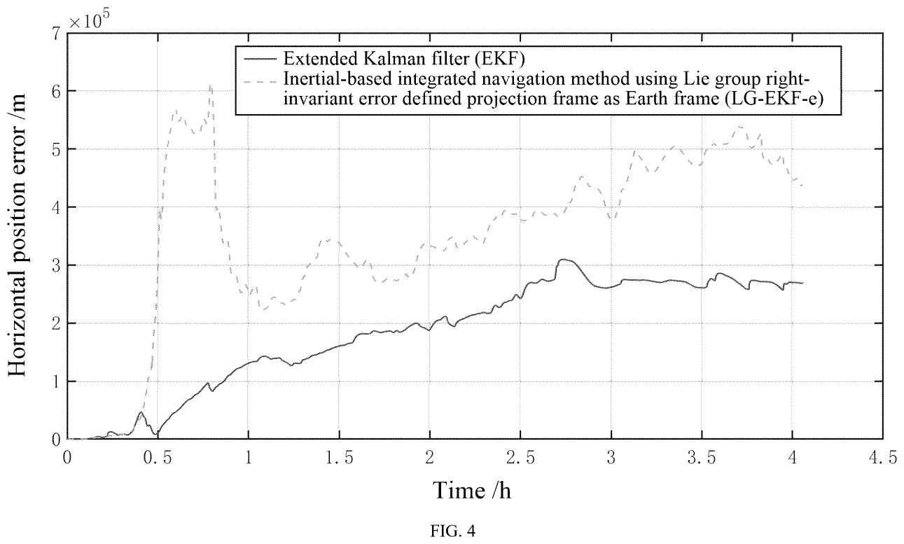

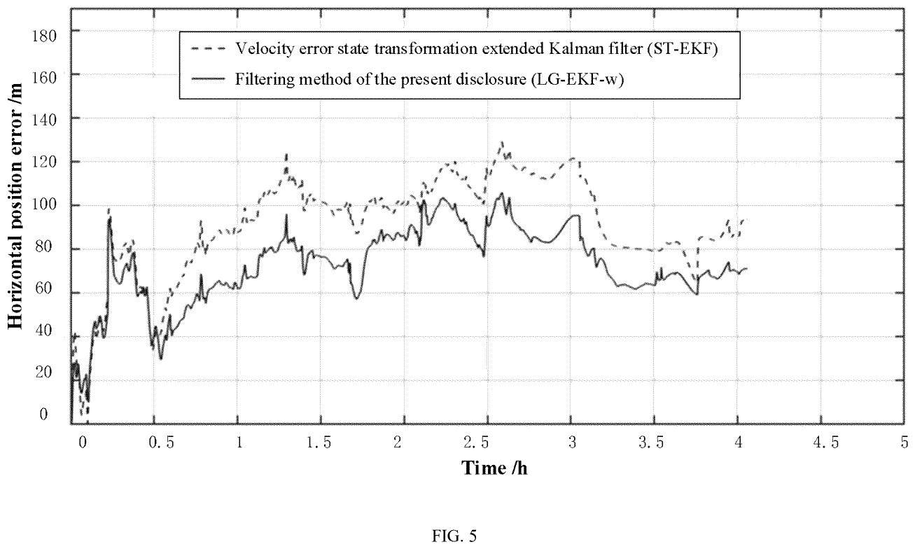

To validate the effectiveness of the inertial-based integrated navigation method for enhancing a Lie group autonomous characteristic proposed in the present disclosure, vehicle experiments are conducted. The experimental setup includes a high-precision fiber optic gyroscope (FOG)-based SINS, a wheel odometer, a satellite receiver, etc. FIG. 2 is a schematic diagram showing the configuration of the vehicle-borne SINS/odometer integrated navigation space. The original data of the SINS accelerometer and gyroscope include: 200 Hz frequency, biases of 0.003°/h and 10 μg, and random walks of 0.0003°/sqrt (h) and 1 μg/sqrt (Hz). The odometer resolution reaches 0.0011 m/p, and the satellite single-point positioning accuracy exceeds 1 m. To enhance experimental credibility and sufficiency, a set of open-loop trajectory experiments are performed, with the trajectory shown in FIG. 3. Four filtering schemes are implemented: extended Kalman filter (EKF), velocity error state transformation extended Kalman filter (ST-EKF), inertial-based integrated navigation method using a Lie group right-invariant error defined projection frame as the Earth frame (LG-EKF-e), and the inertial-based integrated navigation method for enhancing a Lie group autonomous characteristic (LG-EKF-w) proposed in the present disclosure. FIG. 4 is a comparison diagram of integrated navigation results between EKF and LG-EKF-e under initial horizontal attitude error angle of 1° and a heading error angle of 180°. FIG. 5 is a comparison diagram of integrated navigation results between ST-EKF and LG-EKF-w under initial horizontal attitude error angle of 1° and a heading error angle of 180°. The results demonstrate that EKF exhibits the worst positioning accuracy, while LG-EKF-w achieves optimal positioning performance under large initial misalignment angles.

An embodiment provides an inertial-based integrated navigation device for enhancing a Lie group autonomous characteristic, including a first module, a second module, a third module, a fourth module, and a fifth module.

The first module is configured to receive SINS navigation information, odometer navigation information, and positioning system navigation information of a moving body.

The second module is configured to construct, according to an initial navigation state and the SINS navigation information of the moving body, a world frame projection-based Kalman filter system equation for enhancing a Lie group autonomous characteristic.

The third module is configured to take an estimated velocity of an odometer as an observed quantity, and construct a velocity observation equation.

The fourth module is configured to perform inertial-based integrated navigation according to the world frame projection-based Kalman filter system equation for enhancing a Lie group autonomous characteristic and the velocity observation equation, and obtain an inertial-based integrated navigation state and covariance as a Kalman filter's observation-updated state and covariance.

The fifth module is configured to perform attitude, velocity, and position updates according to a Lie group error state transformation.

The implementation methods for each of the above modules and the construction of the model can adopt the approaches described in any of the above embodiments, and as such, they will not be reiterated here.

In another aspect, the present disclosure provides a computer device, including a memory and a processor. The memory is configured to store a computer program. The computer program is executable by the processor to implement the steps of the inertial-based integrated navigation method and device for enhancing a Lie group autonomous characteristic in any one of the above embodiments. The computer device may be a server. The computer device includes a processor, a memory, a network interface, and a database that are connected through a system bus. The processor of the computer device is configured to provide calculation and control capabilities. The memory of the computer device includes a nonvolatile storage medium and an internal memory. The nonvolatile storage medium stores an operating system, a computer program, and a database. The internal memory provides an environment for operation of the operating system and the computer program in the nonvolatile storage medium. The database of the computer device is configured to store data. The network interface of the computer device is configured to communicate with an external terminal through a network.

In another aspect, the present disclosure provides a computer-readable storage medium. The computer-readable storage medium is configured to store a computer program. The computer program is executable by a processor to implement the steps of the inertial-based integrated navigation method and device for enhancing a Lie group autonomous characteristic in any one of the above embodiments.

Those of ordinary skill in the art may understand that all or some of the procedures in the method of the above embodiments may be implemented by a computer program instructing related hardware. The computer program may be stored in a nonvolatile computer-readable storage medium. When the computer program is executed, the procedures in the embodiments of the above method may be performed. Any reference to a memory, a storage, a database, or other mediums used in various embodiments provided in the present disclosure may include a nonvolatile memory and/or a volatile memory. The nonvolatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As description rather than limitation, the RAM can be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchronization link (Synchlink) DRAM (SLDRAM), a Rambus direct RAM (RDRAM), a direct Rambus dynamic RAM (DRDRAM), and a Rambus dynamic RAM (RDRAM).

Content not mentioned in the present disclosure shall be a widely-known technology.

The technical characteristics of the above embodiments can be employed in arbitrary combinations. To provide a concise description of these embodiments, all possible combinations of all the technical characteristics of the above embodiments may not be described; however, these combinations of the technical characteristics should be construed as falling within the scope defined by the specification as long as no contradiction occurs.

The above embodiments only represent some implementations of the present disclosure, and the description thereof is more specific and detailed, but cannot be construed as a limitation on the scope of the present disclosure. It should be noted that, for a person of ordinary skill in the art, several variations and improvements can be made without departing from the concept of the present disclosure, all of which fall within the protection scope of the present disclosure. Therefore, the protection scope of the present disclosure should be subject to the protection scope defined by the claims.

The above described are merely preferred embodiments of the present disclosure and is not intended to limit the present disclosure, and various changes and modifications of the present disclosure may be made by those skilled in the art. Any modification, equivalent substitution, improvement, etc. within the spirit and principles of the present disclosure shall fall within the scope of protection of the present disclosure.

What is claimed is:

1. An inertial-based integrated navigation method for enhancing a Lie group autonomous characteristic, comprising:
receiving strapdown inertial navigation system (SINS) navigation information, odometer navigation information, and positioning system navigation information of a moving body;
constructing, according to an initial navigation state and the SINS navigation information of the moving body, a world frame projection-based Kalman filter system equation for enhancing the Lie group autonomous characteristic as follows:
$${\dot{x}}_{LGEKF - INS - Odo - W - R} = {F}_{LGEKF - INS - Odo - W - R} {x}_{LGEKF - INS - Odo - W - R} + {G}_{LGEKF - INS - Odo - W - R} {w}_{gyro \_ acc \_ odo}$$
wherein SINS frame is denoted as a b-frame, world frame is denoted as a w-frame, and \dot{x}_{LGEKF-INS-Odo-W-R} denotes a derivative of a filter state vector x_{LGEKF-INS-Odo-W-R};
$${F}_{LGEKF - INS - Odo - W - R} = [ \begin{matrix}{F}_{LGEKF - INS - W - R} & {0}_{15 \times 1} & {0}_{15 \times 1} & {0}_{15 \times 1} & {0}_{15 \times 3} \\ {0}_{1 \times 15} & - \frac{1}{{τ}_{odo}} & 0 & 0 & {0}_{1 \times 3} \\ {0}_{1 \times 15} & 0 & 0 & 0 & {0}_{1 \times 3} \\ {0}_{1 \times 15} & 0 & 0 & 0 & {0}_{1 \times 3} \\ {0}_{3 \times 15} & {0}_{3 \times 1} & {0}_{3 \times 1} & {0}_{3 \times 1} & {0}_{3 \times 3}\end{matrix} ]$$
$${F}_{LGEKF - INS - W - R} = [ \begin{matrix}( - {ω}_{ie}^{w} \times ) & {0}_{3 \times 3} & {0}_{3 \times 3} & - {C}_{b}^{w} & {0}_{3 \times 3} \\ [ ( {\tilde{γ}}_{ib}^{w} - {( {ω}_{ie}^{w} \times )}^{2} ( {r}_{ew}^{w} + {r}_{wb ( 0 )}^{w} ) ) \times ] & - ( {ω}_{ie}^{w} \times ) & {0}_{3 \times 3} & - [ ( {\tilde{v}}_{ib}^{w} - ( {ω}_{ie}^{w} \times ) ( {r}_{ew}^{w} + {r}_{wb ( 0 )}^{w} ) ) \times ] {C}_{b}^{w} & - {C}_{b}^{w} \\ {0}_{3 \times 3} & {I}_{3} & - ( {ω}_{ie}^{w} \times ) & - [ ( {\tilde{r}}_{wb}^{w} - {r}_{wb ( 0 )}^{w} ) \times ] {C}_{b}^{w} & {0}_{3 \times 3} \\ {0}_{3 \times 3} & {0}_{3 \times 3} & {0}_{3 \times 3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3}\end{matrix} ]$$
$${w}_{gyro \_ acc \_ odo} = {[ \begin{matrix}{w}_{gx} & {w}_{gy} & {w}_{gz} & {w}_{ax} & {w}_{ay} & {w}_{az} & {w}_{odo}\end{matrix} ]}^{T}$$
$${G}_{LGEKF - INS - Odo - W - R} = [ \begin{matrix}- {C}_{b}^{w} & {0}_{3 \times 3} & {0}_{3 \times 1} \\ - [ ( {\tilde{v}}_{ib}^{w} - ( {ω}_{ie}^{w} \times ) ( {r}_{ew}^{w} + {r}_{wb ( 0 )}^{w} ) ) \times ] {C}_{b}^{w} & - {C}_{b}^{w} & {0}_{3 \times 1} \\ - [ ( {\tilde{r}}_{wb}^{w} - {r}_{wb ( 0 )}^{w} ) \times ] {C}_{b}^{w} & {0}_{3 \times 3} & {0}_{3 \times 1} \\ {0}_{6 \times 3} & {0}_{6 \times 3} & {0}_{6 \times 1} \\ {0}_{1 \times 3} & {0}_{1 \times 3} & 1 \\ {0}_{5 \times 3} & {0}_{5 \times 3} & {0}_{5 \times 1}\end{matrix} ]$$
wherein τ_{odo} denotes correlation time of a first-order Markov process,
$${ω}_{ie}^{w}$$
denotes projection of an Earth rotation vector onto the w-frame;
$${C}_{b}^{w}$$
denotes direction cosine matrix from the b-frame to the w-frame;
$${\tilde{γ}}_{ib}^{w}$$
denotes computed value of gravitational acceleration projected onto the w-frame;
$${r}_{ew}^{w}$$
denotes projection of position of the w-frame relative to an e-frame onto the w-frame, wherein the e-frame is Earth frame;
$${r}_{w b ( 0 )}^{w}$$
denotes projection of initial position of the moving body relative to the w-frame onto the w-frame;
$${\tilde{v}}_{ib}^{w}$$
denotes computed value of projection of velocity of the moving body relative to inertial frame onto the w-frame;
$${\tilde{r}}_{w b}^{w}$$
denotes computed value of projection of position of the moving body relative to the w-frame onto the w-frame; x denotes conversion of a vector into a corresponding antisymmetric matrix; wₐ=[wₐₓ w_{ay} w_{az}]^{T} and w_{g}=[w_{gx} w_{gy} w_{gz}]^{T} denote accelerometer noise vector and gyroscope noise vector, respectively; and w_{odo} denotes odometer noise;
taking an estimated velocity of an odometer as an observed quantity, and constructing a velocity observation equation;
performing an inertial-based integrated navigation according to the world frame projection-based Kalman filter system equation for enhancing the Lie group autonomous characteristic and the velocity observation equation, and obtaining an inertial-based integrated navigation state and covariance as a Kalman filter's observation-updated state and covariance; and
performing an attitude update, a velocity update, and a position update according to a Lie group error state transformation.

2. The inertial-based integrated navigation method for enhancing the Lie group autonomous characteristic according to claim 1, wherein the SINS navigation information comprises: a first navigation timestamp, a roll angle, a pitch angle, a heading angle, a longitude, a latitude, an altitude, and three-dimensional velocity information in local navigation frame;
the odometer navigation information comprises a second navigation timestamp and body velocity; and
the positioning system navigation information is obtained from a satellite positioning system or an acoustic positioning system, and comprises a third navigation timestamp and absolute three-dimensional positioning information.

3. The inertial-based integrated navigation method for enhancing the Lie group autonomous characteristic according to claim 2, wherein the filter state vector x_{LGEKF-INS-Odo-W-R} is defined as follows:
$${x}_{LGEKF - INS - Odo - W - R} = {[ \begin{matrix}{( {ϕ}_{w b}^{w} )}^{T} & {( J {ρ}_{vib}^{wR} )}^{T} & {( J {ρ}_{rwb}^{wR} )}^{T} & {( {ε}^{b} )}^{T} & {( {∇}^{b} )}^{T} & δ {k}_{odo} & {α}_{θ} & {α}_{ψ} & {( δ {L}^{b} )}^{T}\end{matrix} ]}^{T}$$
wherein
$${ϕ}_{w b}^{w}$$
denotes attitude error vector of SINS;
$$J {ρ}_{vib}^{wR}$$
denotes right Lie group velocity error vector defined relative to the inertial frame and projected onto the w-frame;
$$J {ρ}_{rwb}^{wR}$$
denotes right Lie group position error vector defined relative to the w-frame and projected onto the w-frame; ε^{b} denotes gyroscope constant bias vector; ∇^{b} denotes accelerometer constant bias vector; δk_{odo} denotes an odometer scale factor error; and α_{θ}, α_{ψ}, δL^{b} denote pitch installation misalignment angle and yaw installation misalignment angle between the SINS and the odometer and lever arm error vector, modeled as:
$$δ {\dot{k}}_{odo} = - \frac{1}{{τ}_{odo}} δ {k}_{odo} + {w}_{odo} , {\dot{α}}_{θ} = 0 , {\dot{α}}_{ψ} = 0 , δ {\dot{L}}^{b} = {0}_{3 \times 1}$$
wherein τ_{odo} denotes the correlation time of the first-order Markov process; and w_{odo} denotes the odometer noise.

4. The inertial-based integrated navigation method for enhancing the Lie group autonomous characteristic according to claim 3, wherein a differential equation for the attitude error vector
$${ϕ}_{wb}^{w}$$
of the SINS is:
$${\dot{ϕ}}_{wb}^{w} \approx - ( {ω}_{ie}^{w} \times ) {ϕ}_{wb}^{w} - {\tilde{C}}_{b}^{w} δ {ω}_{ib}^{b}$$
wherein
$${ω}_{ie}^{w}$$
denotes the projection of the Earth rotation vector onto the w-frame;
$${\tilde{C}}_{b}^{w}$$
denotes computed value of the direction cosine matrix from the b-frame to the w-frame; and δω_{ib}^{b} denotes gyroscope error.

5. The inertial-based integrated navigation method for enhancing the Lie group autonomous characteristic according to claim 3, wherein a differential equation for the right Lie group velocity error
$$J {ρ}_{vib}^{wR} \text{is:} \\ J {\dot{ρ}}_{vib}^{wR} \approx [ {\tilde{γ}}_{ib}^{w} - {( {ω}_{ie}^{w} \times )}^{2} ( {r}_{ew}^{w} + {r}_{wb ( 0 )}^{w} ) ] {ϕ}_{eb}^{w} - ( {ω}_{ie}^{w} \times ) J {ρ}_{vib}^{wR} - δ {γ}_{ib}^{w} - [ ( {\tilde{v}}_{ib}^{w} - ( {ω}_{ie}^{w} \times ) ( {r}_{ew}^{w} + {r}_{wb ( 0 )}^{w} ) ) \times ] {\tilde{C}}_{b}^{w} δ {ω}_{ib}^{b} - {\tilde{C}}_{b}^{w} δ {f}_{ib}^{b}$$
wherein
$${ϕ}_{eb}^{w}$$
denotes projection or the attitude error vector of the SINS relative to the e-frame onto the w-frame; and
$$δ {f}_{ib}^{b}$$
denotes accelerometer error.

6. The inertial-based integrated navigation method for enhancing the Lie group autonomous characteristic according to claim 3, wherein a differential equation for the right Lie group position error vector
$$J {ρ}_{rwb}^{wR} \text{is:} \\ J {\dot{p}}_{rwb}^{wR} \approx J {p}_{vib}^{wR} - ( {ω}_{ie}^{w} \times ) J {p}_{rwb}^{wR} - [ ( {\tilde{r}}_{wb}^{w} - {r}_{wb ( 0 )}^{w} ) \times ] {\tilde{C}}_{b}^{w} δ {ω}_{ib}^{b}$$
wherein
$${\tilde{C}}_{b}^{w}$$
denotes computed value of the direction cosine matrix from the b-frame to the w-frame; and
$$δ {ω}_{ib}^{b}$$
denotes gyroscope error.

7. The inertial-based integrated navigation method for enhancing the Lie group autonomous characteristic according to claim 3, wherein the gyroscope constant bias vector, the accelerometer constant bias vector, the lever arm error vector, and the pitch installation misalignment angle and the yaw installation misalignment angle between the SINS and the odometer are considered constant, and the odometer scale factor error is considered as the first-order Markov process, with respective differential equations defined as follows:
$${\dot{ε}}^{b} = 0 , {\dot{∇}}^{b} = 0 \\ δ {\dot{k}}_{odo} = - \frac{1}{{τ}_{odo}} δ {k}_{odo} + {w}_{odo} , {\dot{α}}_{θ} = 0 , {\dot{α}}_{ψ} = 0 , δ {\dot{L}}^{b} = {0}_{3 \times 1} .$$

8. The inertial-based integrated navigation method for enhancing the Lie group autonomous characteristic according to claim 4, wherein the estimated velocity of the odometer is obtained by applying a lever arm correction to a velocity computed by the SINS:
the velocity observation equation is constructed as:
$${δ𝓏}_{v} = {\tilde{v}}_{INS \_ odo}^{m} - {\tilde{v}}_{odo}^{m} = {H}_{v \_ LGEKF - INS - Odo - W - R} {x}_{LGEKF - INS - Odo - W - R} + {υ}_{odo}$$
wherein
$${\tilde{v}}_{INS\_odo}^{m}$$
denotes equivalent velocity computed by the SINS and projected onto an m-frame, wherein the m-frame is odometer frame;
$${\tilde{v}}_{odo}^{m}$$
denotes velocity output by the odometer in the m-frame; and velocity observation matrix is
$${H}_{v\_LGEKF - INS - Odo - W - R} = [ \begin{matrix}\begin{matrix}\begin{matrix}\begin{matrix}\begin{matrix}{0}_{3 \times 3} & - {C}_{b}^{m} {C}_{w}^{b}\end{matrix} & {C}_{b}^{m} {C}_{w}^{b} ( {ω}_{i e}^{w} \times )\end{matrix} & {0}_{3 \times 6}\end{matrix} & {M}_{v}^{b}\end{matrix} & {C}_{b}^{m} ( {ω}_{w b}^{b} \times )\end{matrix} ] ;$$
υ_{odo} denotes velocity observation noise;
$${C}_{b}^{m}$$
denotes attitude transformation matrix from the b-frame to the m-frame;
$${C}_{w}^{b}$$
denotes attitude transformation matrix from the w-frame to the b-frame; and
$${ω}_{w b}^{b}$$
denotes projection or angular velocity of the moving body relative to the w-frame onto the SINS frame; and
$${M}_{v}^{b} = [ \begin{matrix}- {v}_{odo} & 0 & 0 \\ 0 & 0 & - {v}_{odo} \\ 0 & {v}_{odo} & 0\end{matrix} ] ,$$
and
ν_{odo} denotes forward velocity of the odometer.

9. The inertial-based integrated navigation method for enhancing the Lie group autonomous characteristic according to claim 8, wherein in the step of performing the attitude update, the velocity update, and the position update according to the Lie group error state transformation, the attitude update, the velocity update, and the position update are:
$$[ \begin{matrix}{C}_{b}^{w} & {v}_{i b}^{w} - ( {ω}_{i e}^{w} \times ) ( {r}_{e w}^{w} + {r}_{wb ( 0 )}^{w} ) & {r}_{w b}^{w} - {r}_{wb ( 0 )}^{w} \\ {0}_{1 \times 3} & 1 & 0 \\ {0}_{1 \times 3} & 0 & 1\end{matrix} ] = [ \begin{matrix}exp ( {ϕ}_{w b}^{w} \times ) & J {ρ}_{v i b}^{w R} & J {ρ}_{r w b}^{w R} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{i b}^{w} - ( {ω}_{i e}^{w} \times ) ( {r}_{e w}^{w} + {r}_{wb ( 0 )}^{w} ) & {\tilde{r}}_{w b}^{w} - {r}_{wb ( 0 )}^{w} \\ {0}_{1 \times 3} & 1 & 0 \\ {0}_{1 \times 3} & 0 & 1\end{matrix} ] \approx \\ [ \begin{matrix}{I}_{3} + ( {ϕ}_{w b}^{w} \times ) & J {ρ}_{v i b}^{w R} & J {ρ}_{r w b}^{w R} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{i b}^{w} - ( {ω}_{i e}^{w} \times ) ( {r}_{e w}^{w} + {r}_{wb ( 0 )}^{w} ) & {\tilde{r}}_{w b}^{w} - {r}_{wb ( 0 )}^{w} \\ {0}_{1 \times 3} & 1 & 0 \\ {0}_{1 \times 3} & 0 & 1\end{matrix} ]$$
wherein
$${v}_{ib}^{w}$$
denotes the projection of the velocity of the moving body relative to the inertial frame onto the w-frame;
$${\tilde{v}}_{ib}^{w}$$
denotes the computed value of the projection of the velocity of the moving body relative to the inertial frame onto the w-frame;
$${r}_{w b}^{w}$$
denotes the projection of the position of the moving body relative to the w-frame onto the w-frame; and
$${\tilde{r}}_{w b}^{w}$$
denotes the computed value of the projection of the position of the moving body relative to the w-frame onto the w-frame.

10. An inertial-based integrated navigation device for enhancing a Lie group autonomous characteristic, comprising:
a first module, configured to receive SINS navigation information, odometer navigation information, and positioning system navigation information of a moving body;
a second module, configured to construct, according to an initial navigation state and the SINS navigation information of the moving body, a world frame projection-based Kalman filter system equation for enhancing the Lie group autonomous characteristic as follows:
$${\dot{x}}_{LGEKF - INS - Odo - W - R} = {F}_{LGEKF - INS - Odo - W - R} {x}_{LGEKF - INS - Odo - W - R} + {G}_{LGEKF - INS - Odo - W - R} {w}_{gyro\_acc \_odo}$$
wherein SINS frame is denoted as a b-frame, world frame is denoted as a w-frame, and \dot{x}_{LGEKF-INS-Odo-W-R} denotes a derivative of a filter state vector x_{LGEKF-INS-Odo-W-R};
$${F}_{LGEKF - INS - Odo - W - R} = [ \begin{matrix}{F}_{LGEKF - INS - W - R} & {0}_{15 \times 1} & {0}_{15 \times 1} & {0}_{15 \times 1} & {0}_{15 \times 3} \\ {0}_{1 \times 15} & - \frac{1}{{τ}_{odo}} & 0 & 0 & {0}_{1 \times 3} \\ {0}_{1 \times 15} & 0 & 0 & 0 & {0}_{1 \times 3} \\ {0}_{1 \times 15} & 0 & 0 & 0 & {0}_{1 \times 3} \\ {0}_{3 \times 15} & {0}_{3 \times 1} & {0}_{3 \times 1} & {0}_{3 \times 1} & {0}_{3 \times 3}\end{matrix} ]$$
$${F}_{LGEKF - INS - W - R} = [ \begin{matrix}- ( {ω}_{ie}^{w} \times ) & {0}_{3 \times 3} & {0}_{3 \times 3} & - {C}_{b}^{w} & {0}_{3 \times 3} \\ [ ( {\tilde{γ}}_{ib}^{w} - {( {ω}_{i e}^{w} \times )}^{2} ( {r}_{e w}^{w} + {r}_{wb ( 0 )}^{w} ) ) \times ] & - ( {ω}_{ie}^{w} \times ) & {0}_{3 \times 3} & - [ ( {\tilde{v}}_{i b}^{w} - ( {ω}_{i e}^{w} \times ) ( {r}_{e w}^{w} + {r}_{wb ( 0 )}^{w} ) ) \times ] {C}_{b}^{w} & - {C}_{b}^{w} \\ {0}_{3 \times 3} & {I}_{3} & - ( {ω}_{ie}^{w} \times ) & - [ ( {\tilde{r}}_{w b}^{w} - {r}_{wb ( 0 )}^{w} ) \times ] {C}_{b}^{w} & {0}_{3 \times 3} \\ {0}_{3 \times 3} & {0}_{3 \times 3} & {0}_{3 \times 3} & {0}_{3 \times 3} & {0}_{3 \times 3} \\ {0}_{3 \times 3} & {0}_{3 \times 3} & {0}_{3 \times 3} & {0}_{3 \times 3} & {0}_{3 \times 3}\end{matrix} ]$$
$${w}_{gyro\_acc \_odo} = {[ \begin{matrix}\begin{matrix}\begin{matrix}\begin{matrix}\begin{matrix}\begin{matrix}{w}_{gx} & {w}_{gy}\end{matrix} & {w}_{gz}\end{matrix} & {w}_{ax}\end{matrix} & {w}_{ay}\end{matrix} & {w}_{az}\end{matrix} & {w}_{odo}\end{matrix} ]}^{T}$$
$${G}_{LGEKF - INS - Odo - W - R} = [ \begin{matrix}- {C}_{b}^{w} & {0}_{3 \times 3} & {0}_{3 \times 1} \\ - [ ( {\tilde{v}}_{i b}^{w} - ( {ω}_{i e}^{w} \times ) ( {r}_{e w}^{w} + {r}_{wb ( 0 )}^{w} ) ) \times ] {C}_{b}^{w} & - {C}_{b}^{w} & {0}_{3 \times 1} \\ - [ ( {\tilde{r}}_{w b}^{w} - {r}_{wb ( 0 )}^{w} ) \times ] {C}_{b}^{w} & {0}_{3 \times 3} & {0}_{3 \times 1} \\ {0}_{6 \times 3} & {0}_{6 \times 3} & {0}_{6 \times 1} \\ {0}_{1 \times 3} & {0}_{1 \times 3} & 1 \\ {0}_{5 \times 3} & {0}_{5 \times 3} & {0}_{5 \times 1}\end{matrix} ]$$
wherein τ_{odo} denotes correlation time of a first-order Markov process;
$${ω}_{ie}^{w}$$
denotes projection of an Earth rotation vector onto the w-frame;
$${C}_{b}^{w}$$
denotes direction cosine matrix from the b-frame to the w-frame;
$${\tilde{γ}}_{ib}^{w}$$
denotes computed value of gravitational acceleration projected onto the w-frame;
$${r}_{ew}^{w}$$
denotes projection of position of the w-frame relative to an e-frame onto the w-frame, wherein the e-frame is Earth frame;
$${r}_{wb ( 0 )}^{w}$$
denotes projection of initial position of the moving body relative to the w-frame onto the w-frame;
$${\tilde{v}}_{ib}^{w}$$
denotes computed value of projection of velocity of the moving body relative to inertial frame onto the w-frame;
$${\tilde{r}}_{wb}^{w}$$
denotes computed value of projection of position of the moving body relative to the w-frame onto the w-frame; x denotes conversion of a vector into a corresponding antisymmetric matrix; wₐ=[wₐₓ w_{ay} w_{az}]_{T} and w_{g}=[w_{gx} w_{gy} w_{gz}]^{T} denote accelerometer noise vector and gyroscope noise vector, respectively; and w_{odo} denotes odometer noise;
a third module, configured to take an estimated velocity of an odometer as an observed quantity, and construct a velocity observation equation;
a fourth module, configured to perform an inertial-based integrated navigation according to the world frame projection-based Kalman filter system equation for enhancing the Lie group autonomous characteristic and the velocity observation equation, and obtain an inertial-based integrated navigation state and covariance as a Kalman filter's observation-updated state and covariance; and
a fifth module, configured to perform an attitude update, a velocity update, and a position update according to a Lie group error state transformation.

11. The inertial-based integrated navigation method for enhancing the Lie group autonomous characteristic according to claim 5, wherein the estimated velocity of the odometer is obtained by applying a lever arm correction to a velocity computed by the SINS:
the velocity observation equation is constructed as:
$$\begin{matrix}δ {z}_{v} = {\tilde{v}}_{INS \_ odo}^{m} - {\tilde{v}}_{odo}^{m} \\ = {H}_{v \_ LGEKF - INS - Odo - W - R} {x}_{LGEKF - INS - Odo - W - R} + {v}_{odo}\end{matrix}$$
wherein
$${\tilde{v}}_{INS \_ odo}^{m}$$
denotes equivalent velocity computed by the SINS and projected onto an m-frame, wherein the m-frame is odometer frame;
$${\tilde{v}}_{odo}^{m}$$
denotes velocity output by the odometer in the m-frame; and velocity observation matrix is
$${H}_{v \_ LGEKF - INS - Odo - W - R} = [ \begin{matrix}{0}_{3 \times 3} & - {C}_{b}^{m} {C}_{w}^{b} & {C}_{b}^{m} {C}_{w}^{b} ( {ω}_{ie}^{w} \times ) & {0}_{3 \times 6} & {M}_{v}^{b} & {C}_{b}^{m} ( {ω}_{wb}^{b} \times )\end{matrix} ] ;$$
υ_{odo} denotes velocity observation noise;
$${C}_{b}^{m}$$
denotes attitude transformation matrix from the b-frame to the m-frame;
$${C}_{w}^{b}$$
denotes attitude transformation matrix from the w-frame to the b-frame; and
$${ω}_{wb}^{b}$$
denotes projection of angular velocity of the moving body relative to the w-frame onto the SINS frame; and
$${M}_{v}^{b} = [ \begin{matrix}- {v}_{odo} & 0 & 0 \\ 0 & 0 & - {v}_{odo} \\ 0 & {v}_{odo} & 0\end{matrix} ] ,$$
and
ν_{odo} denotes forward velocity of the odometer.

12. The inertial-based integrated navigation method for enhancing the Lie group autonomous characteristic according to claim 6, wherein the estimated velocity of the odometer is obtained by applying a lever arm correction to a velocity computed by the SINS:
the velocity observation equation is constructed as:
$$\begin{matrix}δ {z}_{v} = {\tilde{v}}_{INS \_ odo}^{m} - {\tilde{v}}_{odo}^{m} \\ = {H}_{v \_ LGEKF - INS - Odo - W - R} {x}_{LGEKF - INS - Odo - W - R} + {v}_{odo}\end{matrix}$$
wherein
$${\tilde{v}}_{INS \_ odo}^{m}$$
denotes equivalent velocity computed by the SINS and projected onto an m-frame, wherein the m-frame is odometer frame;
$${\tilde{v}}_{odo}^{m}$$
denotes velocity output by the odometer in the m-frame; and velocity observation matrix is
$${H}_{v \_ LGEKF - INS - Odo - W - R} = [ \begin{matrix}{0}_{3 \times 3} & - {C}_{b}^{m} {C}_{w}^{b} & {C}_{b}^{m} {C}_{w}^{b} ( {ω}_{ie}^{w} \times ) & {0}_{3 \times 6} & {M}_{v}^{b} & {C}_{b}^{m} ( {ω}_{wb}^{b} \times )\end{matrix} ] ;$$
υ_{odo} denotes velocity observation noise;
$${C}_{b}^{m}$$
denotes attitude transformation matrix from the b-frame to the m-frame;
$${C}_{w}^{b}$$
denotes attitude transformation matrix from the w-frame to the b-frame; and
$${ω}_{wb}^{b}$$
denotes projection of angular velocity of the moving body relative to the w-frame onto the SINS frame; and
$${M}_{v}^{b} = [ \begin{matrix}- {v}_{odo} & 0 & 0 \\ 0 & 0 & - {v}_{odo} \\ 0 & {v}_{odo} & 0\end{matrix} ] ,$$
and
ν_{odo} denotes forward velocity of the odometer.

13. The inertial-based integrated navigation method for enhancing the Lie group autonomous characteristic according to claim 7, wherein the estimated velocity of the odometer is obtained by applying a lever arm correction to a velocity computed by the SINS:
the velocity observation equation is constructed as:
$$\begin{matrix}δ {z}_{v} = {\tilde{v}}_{INS \_ odo}^{m} - {\tilde{v}}_{odo}^{m} \\ = {H}_{v \_ LGEKF - INS - Odo - W - R} {x}_{LGEKF - INS - Odo - W - R} + {v}_{odo}\end{matrix}$$
wherein
$${\tilde{v}}_{odo}^{m}$$
denotes equivalent velocity computed by the SINS and projected onto an m-frame, wherein the m-frame is odometer frame;
$${\tilde{v}}_{INS \_ odo}^{m}$$
denotes velocity output by the odometer in the m-frame; and velocity observation matrix is
$${H}_{v \_ LGEKF - INS - Odo - W - R} = [ \begin{matrix}{0}_{3 \times 3} & - {C}_{b}^{m} {C}_{w}^{b} & {C}_{b}^{m} {C}_{w}^{b} ( {ω}_{ie}^{w} \times ) & {0}_{3 \times 6} & {M}_{v}^{b} & {C}_{b}^{m} ( {ω}_{wb}^{b} \times )\end{matrix} ] ;$$
υ_{odo} denotes velocity observation noise;
$${C}_{b}^{m}$$
denotes attitude transformation matrix from the b-frame to the m-frame;
$${C}_{w}^{b}$$
denotes attitude transformation matrix from the w-frame to the b-frame; and
$${ω}_{wb}^{b}$$
denotes projection or angular velocity of the moving body relative to the w-frame onto the SINS frame; and
$${M}_{v}^{b} = [ \begin{matrix}- {v}_{odo} & 0 & 0 \\ 0 & 0 & - {v}_{odo} \\ 0 & {v}_{odo} & 0\end{matrix} ] ,$$
and
ν_{odo} denotes forward velocity of the odometer.

14. The inertial-based integrated navigation method for enhancing the Lie group autonomous characteristic according to claim 11, wherein in the step of performing the attitude update, the velocity update, and the position update according to the Lie group error state transformation, the attitude update, the velocity update, and the position update are:
$$[ \begin{matrix}{C}_{b}^{w} & {v}_{ib}^{w} - ( {ω}_{ie}^{w} \times ) ( {r}_{ew}^{w} + {r}_{wb ( 0 )}^{w} ) & {r}_{wb}^{w} - {r}_{wb ( 0 )}^{w} \\ {0}_{1 \times 3} & 1 & 0 \\ {0}_{1 \times 3} & 0 & 1\end{matrix} ] = [ \begin{matrix}exp ( {ϕ}_{wb}^{w} \times ) & J {ρ}_{vib}^{wR} & J {ρ}_{rwb}^{wR} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{ib}^{w} - ( {ω}_{ie}^{w} \times ) ( {r}_{ew}^{w} + {r}_{wb ( 0 )}^{w} ) & {\tilde{r}}_{wb}^{w} - {r}_{wb ( 0 )}^{w} \\ {0}_{1 \times 3} & 1 & 0 \\ {0}_{1 \times 3} & 0 & 1\end{matrix} ] \approx [ \begin{matrix}{I}_{3} + ( {ϕ}_{wb}^{w} \times ) & J {ρ}_{vib}^{wR} & J {ρ}_{rwb}^{wR} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{ib}^{w} - ( {ω}_{ie}^{w} \times ) ( {r}_{ew}^{w} + {r}_{wb ( 0 )}^{w} ) & {\tilde{r}}_{wb}^{w} - {r}_{wb ( 0 )}^{w} \\ {0}_{1 \times 3} & 1 & 0 \\ {0}_{1 \times 3} & 0 & 1\end{matrix} ]$$
wherein
$${v}_{ib}^{w}$$
denotes the projection of the velocity of the moving body relative to the SINS frame onto the w-frame;
$${\tilde{v}}_{ib}^{w}$$
denotes the computed value of the projection of the velocity of the moving body relative to the SINS frame onto the w-frame;
$${r}_{wb}^{w}$$
denotes the projection of the position of the moving body relative to the w-frame onto the w-frame; and
$${\tilde{r}}_{wb}^{w}$$
denotes the computed value of the projection of the position of the moving body relative to the w-frame onto the w-frame.

15. The inertial-based integrated navigation method for enhancing the Lie group autonomous characteristic according to claim 12, wherein in the step of performing the attitude update, the velocity update, and the position update according to the Lie group error state transformation, the attitude update, the velocity update, and the position update are:
$$[ \begin{matrix}{C}_{b}^{w} & {v}_{ib}^{w} - ( {ω}_{ie}^{w} \times ) ( {r}_{ew}^{w} + {r}_{wb ( 0 )}^{w} ) & {r}_{wb}^{w} - {r}_{wb ( 0 )}^{w} \\ {0}_{1 \times 3} & 1 & 0 \\ {0}_{1 \times 3} & 0 & 1\end{matrix} ] = [ \begin{matrix}exp ( {ϕ}_{wb}^{w} \times ) & J {ρ}_{vib}^{wR} & J {ρ}_{rwb}^{wR} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{ib}^{w} - ( {ω}_{ie}^{w} \times ) ( {r}_{ew}^{w} + {r}_{wb ( 0 )}^{w} ) & {\tilde{r}}_{wb}^{w} - {r}_{wb ( 0 )}^{w} \\ {0}_{1 \times 3} & 1 & 0 \\ {0}_{1 \times 3} & 0 & 1\end{matrix} ] \approx [ \begin{matrix}{I}_{3} + ( {ϕ}_{wb}^{w} \times ) & J {ρ}_{vib}^{wR} & J {ρ}_{rwb}^{wR} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{ib}^{w} - ( {ω}_{ie}^{w} \times ) ( {r}_{ew}^{w} + {r}_{wb ( 0 )}^{w} ) & {\tilde{r}}_{wb}^{w} - {r}_{wb ( 0 )}^{w} \\ {0}_{1 \times 3} & 1 & 0 \\ {0}_{1 \times 3} & 0 & 1\end{matrix} ]$$
wherein
$${v}_{ib}^{w}$$
denotes the projection of the velocity of the moving body relative to the SINS frame onto the w-frame;
$${\tilde{v}}_{ib}^{w}$$
denotes the computed value of the projection of the velocity of the moving body relative to the SINS frame onto the w-frame;
$${r}_{wb}^{w}$$
denotes the projection of the position of the moving body relative to the w-frame onto the w-frame; and
$${\tilde{r}}_{wb}^{w}$$
denotes the computed value of the projection of the position of the moving body relative to the w-frame onto the w-frame.

16. The inertial-based integrated navigation method for enhancing the Lie group autonomous characteristic according to claim 13, wherein in the step of performing the attitude update, the velocity update, and the position update according to the Lie group error state transformation, the attitude update, the velocity update, and the position update are:
$$[ \begin{matrix}{C}_{b}^{w} & {v}_{ib}^{w} - ( {ω}_{ie}^{w} \times ) ( {r}_{ew}^{w} + {r}_{wb ( 0 )}^{w} ) & {r}_{wb}^{w} - {r}_{wb ( 0 )}^{w} \\ {0}_{1 \times 3} & 1 & 0 \\ {0}_{1 \times 3} & 0 & 1\end{matrix} ] = [ \begin{matrix}exp ( {ϕ}_{wb}^{w} \times ) & J {ρ}_{vib}^{wR} & J {ρ}_{rwb}^{wR} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{ib}^{w} - ( {ω}_{ie}^{w} \times ) ( {r}_{ew}^{w} + {r}_{wb ( 0 )}^{w} ) & {\tilde{r}}_{wb}^{w} - {r}_{wb ( 0 )}^{w} \\ {0}_{1 \times 3} & 1 & 0 \\ {0}_{1 \times 3} & 0 & 1\end{matrix} ] \approx [ \begin{matrix}{I}_{3} + ( {ϕ}_{wb}^{w} \times ) & J {ρ}_{vib}^{wR} & J {ρ}_{rwb}^{wR} \\ {0}_{1 \times 3} & 1 & 0 \\ {0}_{1 \times 3} & 0 & 1\end{matrix} ] [ \begin{matrix}{\tilde{C}}_{b}^{w} & {\tilde{v}}_{ib}^{w} - ( {ω}_{ie}^{w} \times ) ( {r}_{ew}^{w} + {r}_{wb ( 0 )}^{w} ) & {\tilde{r}}_{wb}^{w} - {r}_{wb ( 0 )}^{w} \\ {0}_{1 \times 3} & 1 & 0 \\ {0}_{1 \times 3} & 0 & 1\end{matrix} ]$$
wherein
$${v}_{ib}^{w}$$
denotes the projection of the velocity of the moving body relative to the SINS frame onto the w-frame;
$${\tilde{v}}_{ib}^{w}$$
denotes the computed value of the projection of the velocity of the moving body relative to the SINS frame onto the w-frame;
$${r}_{wb}^{w}$$
denotes the projection of the position of the moving body relative to the w-frame onto the w-frame; and
$${\tilde{r}}_{wb}^{w}$$
denotes the computed value of the projection of the position of the moving body relative to the w-frame onto the w-frame.
